(19) United States
(12) Patent Application Publication
(10) Pub. No.: US 2025/0024566 A1
(43) Pub. Date: Jan. 16, 2025

(54) MICROWAVE OVEN COMPRISING MAGNETIC BODY SURROUNDING CURRENT PATH

(71) Applicant: Samsung Electronics Co., Ltd., Suwon-si (KR)

(72) Inventors: Sail MIN, Suwon-si (KR); Hyojeong LEE, Suwon-si (KR); Sooam KIM, Suwon-si (KR); Jeongil OH, Suwon-si (KR); Youngwoong JOO, Suwon-si (KR)

(21) Appl. No.: 18/896,170

(22) Filed: Sep. 25, 2024

Related U.S. Application Data
(63) Continuation of application No. PCT/KR2023/006452, filed on May 12, 2023.

(30) Foreign Application Priority Data
Jul. 11, 2022 (KR) 10-2022-0085271
Oct. 26, 2022 (KR) 10-2022-0139668

(51) Int. Cl. H05B 6/64; H01F 7/02; H01J 23/02; H01J 25/50; H05B 6/68

(52) U.S. Cl. CPC H05B 6/64; H01F 7/0205; H01J 23/02; H01J 25/50; H05B 6/68

(57) ABSTRACT

A microwave oven is provided. The microwave oven includes a main body including a cooking chamber having an opening that is opened forward, and door coupled to the main body and capable of opening/closing the cooking chamber, a magnetron that generates microwaves and is connected to a second side of the cooking chamber, the second side being opposite to a first side to which the door is coupled, a high-voltage capacitor connected to the magnetron, a high-voltage diode connected to the magnetron, a high-voltage transformer connected to the magnetron, and a magnetic body arranged adjacent to a current path connecting the magnetron to the high-voltage capacitor, the high-voltage diode, and the high-voltage transformer, wherein, along the current path, a current flows from the magnetron to the high-voltage capacitor, the high-voltage diode, and the high-voltage transformer, and wherein the magnetic body surrounds the current path.

### CROSS-REFERENCE TO RELATED APPLICATION(S)

This application is a continuation application, claiming priority under § 365 (c), of an International application No. PCT/KR2023/006452, filed on May 12, 2023, which is based on and claims the benefit of a Korean patent application number 10-2022-0085271, filed on Jul. 11, 2022, in the Korean Intellectual Property Office, and of a Korean patent application number 10-2022-0139668, filed on Oct. 26, 2022, in the Korean Intellectual Property Office, the disclosure of each of which is incorporated by reference herein in its entirety.

### BACKGROUND

### 1. Field

The disclosure relates to a microwave oven including a magnetic body surrounding a current path.

### 2. Description of Related Art

A microwave oven may cook food by using microwaves. A microwave oven may include a magnetron for generating microwaves and a high-voltage capacitor connected to the magnetron. The magnetron may be supplied with energy for generating microwaves from a power unit. The power unit may allow a load current to flow toward the magnetron so as to supply energy to the magnetron. The power unit of the microwave oven may be connected to a distribution box. The distribution box may be installed in a building and may distribute electric power to home appliances including the microwave oven. The distribution box may include an arc fault circuit interrupter (AFCI) which blocks an arc generated from the load current introduced into the magnetron via the power unit included in the microwave oven.

In addition, a current may flow from the magnetron to a ground portion via the high-voltage capacitor while generating noise. The current may have a frequency component similar to that of an arc. Accordingly, even when an arc does not actually occur, the AFCI may wrongly recognize that the arc is generated due to the current and then block the power.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a microwave oven including a magnetic body surrounding a current path.

Additional aspects will be set forth in part in the description which follows and, in part, will be apparent from the description, or may be learned by practice of the presented embodiments.

In accordance with an aspect of the disclosure, a microwave oven is provided. The microwave oven includes a main body including a cooking chamber having an opening that is opened forward, a door coupled to the main body and capable of opening/closing the cooking chamber, a magnetron that generates microwaves and is connected to a second side of the cooking chamber, the second side being opposite to a first side to which the door is coupled, a high-voltage capacitor connected to the magnetron, a high-voltage diode connected to the magnetron, a high-voltage transformer connected to the magnetron, and a magnetic body arranged adjacent to a current path connecting the magnetron to the high-voltage capacitor, the high-voltage diode, and the high-voltage transformer, wherein, along the current path, a current flows from the magnetron to the high-voltage capacitor, the high-voltage diode, and the high-voltage transformer, and wherein the magnetic body surrounds the current path.

In accordance with another aspect of the disclosure, a microwave oven is provided. The microwave oven includes a main body including a cooking chamber having an opening that is opened forward, a door coupled to the main body and capable of opening/closing the cooking chamber, a magnetron that generates microwaves and is connected to a second side of the cooking chamber, the second side being opposite to a first side to which the door is coupled, a connector connected to the magnetron, and an interrupt coil arranged adjacent to a current path connecting the magnetron to the connector, wherein along the current path, a current flows from the magnetron to the connector, and wherein the interrupt coil is inserted into the magnetron or the connector so as to surround the current path.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a microwave oven according to an embodiment of the disclosure;

FIG. 2 is a block diagram illustrating an interrupt circuit according to an embodiment of the disclosure;

FIG. 3 is a waveform diagram of an input current of a microwave oven and a current flowing in a high-voltage capacitor, according to an embodiment of the disclosure;

FIG. 4 is a waveform diagram of an arc current and voltage of a power unit when a general arc occurs according to an embodiment of the disclosure;

FIG. 5 is a waveform diagram of a voltage of a power unit in a microwave oven, according to an embodiment of the disclosure;

FIG. 6 is a diagram of a microwave oven according to an embodiment of the disclosure;

FIG. 7 is a diagram illustrating a microwave oven according to an embodiment of the disclosure;

FIG. 8A is a diagram illustrating a magnetron, a high-voltage capacitor, a high-voltage diode, a high-voltage transformer, a current path, and a magnetic body in a microwave oven, according to an embodiment of the disclosure;

FIG. 8B is a circuit diagram illustrating a magnetron, a high-voltage capacitor, a high-voltage diode, a high-voltage transformer, and a power unit in a microwave oven, according to an embodiment of the disclosure;

FIG. 9 is a diagram illustrating a microwave oven operating in a differential mode according to an embodiment of the disclosure;

FIG. 10 is a diagram illustrating a microwave oven operating in a common mode according to an embodiment of the disclosure;

FIG. 11 is a diagram illustrating a magnetron, a connector, and a blocking coil in a microwave oven, according to an embodiment of the disclosure;

FIG. 12 is a diagram illustrating a magnetron, a connector, and a blocking coil in a microwave oven, according to an embodiment of the disclosure; and

FIG. 13 is a waveform diagram of a voltage of a microwave oven including a magnetic body, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. In addition, some terms may be arbitrarily selected by the applicant. In this case, the meaning of the selected terms will be described in the detailed description of an embodiment of the disclosure. Thus, the terms used herein have to be defined based on the meaning of the terms together with the description throughout the specification.

It will be further understood that the terms “comprises” and/or “comprising,” when used in this specification, specify the presence of stated components, but do not preclude the presence or addition of one or more components. In addition, the terms, such as “ . . . unit”, “module”, or the like, provided herein indicates a unit performing at least one function or operation, and may be realized by hardware, software, or a combination of hardware and software.

Hereinafter, one or more embodiments of the disclosure will be described with reference to accompanying drawings to the extent that one of ordinary skill in the art would be able to carry out the disclosure. However, an embodiment of the disclosure may be implemented in various manners, and is not limited to one or more embodiments of the disclosure described herein. In addition, components irrelevant with the description are omitted in the drawings for clear description of an embodiment of the disclosure, and like reference numerals are used for similar components throughout the entire specification of the disclosure.

According to an embodiment of the disclosure, provided is a microwave oven in which a magnetic body is arranged to surround a current path through which a current generating noise flows so that the current generating noise is suppressed and mis-recognition of an arc fault circuit interrupter (AFCI) is reduced.

According to an embodiment of the disclosure, provided is a microwave oven in which mis-recognition of the arc fault circuit interrupter (AFCI) is reduced and an issue of blocking a load current of a power unit even when an arc does not generate from the load current of the power unit may be reduced.

According to an embodiment of the disclosure, provided is a microwave oven that may stably operate by reducing an issue of unnecessarily blocking a load current of a power unit due to a mis-recognition regarding arc generation.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

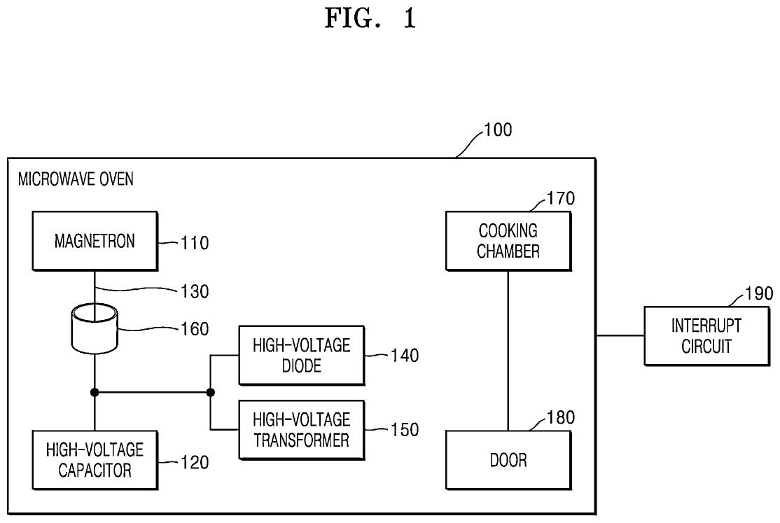

FIG. 1 is a diagram illustrating a microwave oven according to an embodiment of the disclosure.

Referring to FIG. 1, a microwave oven 100 may defrost or cook food by using microwaves. The microwave oven 100 may include a home microwave oven that may heat a relatively small amount of food, a commercial microwave oven that may heat a relatively large amount of food, and a combination oven range that has functions of both an oven and a microwave oven. The microwave oven 100 may include a magnetron 110, a high-voltage capacitor 120, a current path 130, a high-voltage diode 140, a high-voltage transformer 150, a magnetic body 160, a cooking chamber 170, and a door 180. The microwave oven 100 may further include components other than the components shown in the drawing. For example, the microwave oven 100 may further include a power unit for receiving electrical energy from the outside, and a cooling portion for cooling down the heat generated from the magnetron 110.

The magnetron 110 may generate microwaves. The magnetron 110 may include a vacuum portion, a negative electrode, a resonance circuit, and an output unit. The vacuum portion may be a part in which an electric field and a magnetic field are formed perpendicularly to each other. The negative electrode may generate an electronic beam in the vacuum portion. The resonance circuit may generate microwaves by generating resonance at a frequency corresponding to an electron beam rotating in the vacuum portion and the microwave. The output unit may radiate the generate microwaves to a heating portion in the microwave oven 100. As described above, the magnetron 110 may generate and output microwaves by using an electromagnetic field effect.

The microwaves may be electromagnetic waves having a wavelength of 1 mm to 1 m and a frequency band of 300 megahertz (MHZ) to 300 gigahertz (GHz). The microwaves may be incident on polar molecules, such as water and transfer energy to water molecules. The water molecules receiving the energy transferred from the microwaves may be heated by changing the direction of energy. The water molecules included in food are heated by using the microwaves generated by the magnetron 110 as described above, and then, the food may be heated.

The high-voltage capacitor 120 may be connected to the magnetron 110. The high-voltage capacitor 120 may smooth a power current introduced into the magnetron 110 and/or a ground voltage output from the magnetron 110 into a direct current (DC). The high-voltage capacitor 120 may charge and discharge a secondary voltage output and boosted by the high-voltage transformer 150. The high-voltage capacitor 120 may double the voltage by charging and discharging the boosted secondary voltage.

The high-voltage diode 140 may be connected to the magnetron 110. The high-voltage diode 140 may generate a DC voltage by rectifying the high voltage. The high-voltage diode 140 may control the flow direction of the current. The high-voltage diode 140 may prevent the current from flowing backward from the ground of the microwave oven to the magnetron 110.

The high-voltage transformer 150 may be connected to the magnetron 110. The high-voltage transformer 150 may transform a load current and voltage introduced from the power unit into a current and voltage used in the magnetron 110. The high-voltage transformer 150 may transfer the transformed current and voltage to the magnetron 110.

The current path 130 may connect the magnetron 110 and the high-voltage capacitor 120 to each other. The current path 130 may connect the magnetron 110 and the high-voltage diode 140 to each other. The current path 130 may connect the magnetron 110 and the high-voltage transformer 150 to each other. The current path 130 may include a plurality of wires. A current flowing from the magnetron 110 to the high-voltage capacitor 120, the high-voltage diode 140, and the high-voltage transformer 150 may flow through the current path 130. The current may generate noise while flowing. For example, the current may be a common mode noise current generating common mode noise.

The cooking chamber 170 may be a space, in which the food may be placed, in a main body of the microwave oven 100. The food placed in the cooking chamber 170 may be heated by the microwaves output from the magnetron 110, and then may be cooked and/or defrosted. The cooking chamber 170 may include an opening opened forward.

The door 180 may be coupled to the main body. The door 180 may be provided at a first side of the cooking chamber 170 in the main body. The door 180 may be provided on the front surface of the cooking chamber 170. The door 180 may open/close the cooking chamber 170. The door 180 may make the cooking chamber 170 a closed space. When the door 180 is closed, the microwave oven 100 operates and the food placed in the cooking chamber 170 may be cooked and/or defrosted.

The power unit of the microwave oven 100 may be connected to a distribution box. The distribution box may be installed in a building and may distribute electric power to home appliances including the microwave oven 100. The distribution box may include an interrupt circuit 190.

The interrupt circuit 190 may interrupt an arc generated by a load current of the microwave oven 100. The load current may be the current flowing from the power unit of the microwave oven 100 to the magnetron 110. The arc may be a surge current that is generated from a certain high-frequency band in the load current. The interrupt circuit 190 may be an arc fault circuit interrupter (AFCI). When recognizing that an arc is generated, the AFCI may interrupt the power. Application range of the AFCI has been increasing so that the AFCI is mandatorily installed in the distribution box.

The magnetic body 160 may encompass the current path 130. The magnetic body 160 may be arranged so as to at least partially surround the current path 130. The magnetic body 160 may shield the current flowing through the current path 130. The magnetic body 160 may reduce the generation of noise in the current path 130.

The microwave oven 100 according to an embodiment of the disclosure arranges the magnetic body 160 to surround the current path 130 in which the current generating the noise flows, and thus, restrains the current generating the noise and reduces mis-recognition of the AFCI.

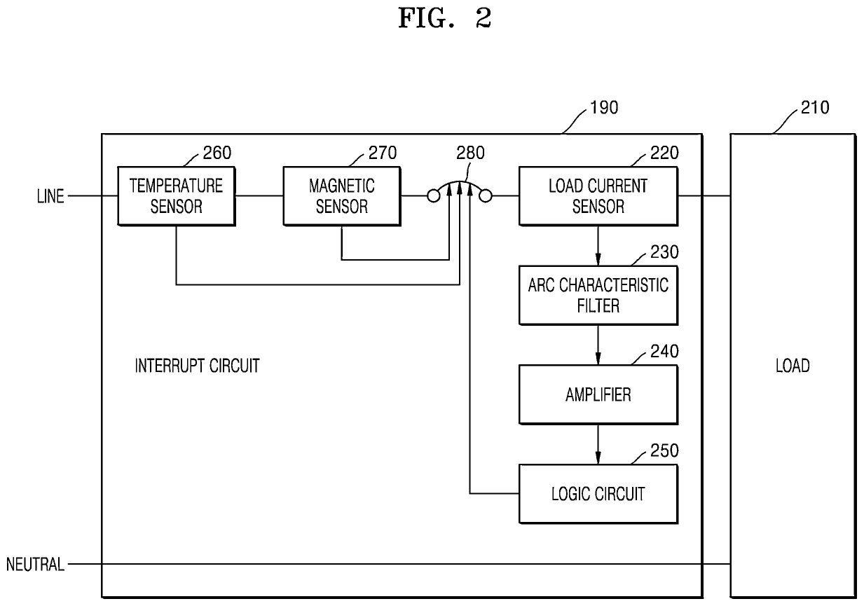

Hereinafter, detailed configurations and functions of the interrupt circuit 190 are described below with reference to FIG. 2. The interrupt circuit 190 may be an AFCI installed in the distribution box.

FIG. 2 is a block diagram illustrating an interrupt circuit according to an embodiment of the disclosure.

Referring to FIG. 2, the interrupt circuit 190 may be connected to a load 210 of the microwave oven. The load 210 may be connected to a line wiring and a neutral wiring so as to supply a load current. The interrupt circuit 190 may detect the arc generated from the load current introduced from the load 210. The interrupt circuit 190 may interrupt the power when the arc is generated in the load current. The interrupt circuit 190 may include a load current sensor 220, an arc characteristic filter 230, an amplifier 240, a logic circuit 250, a temperature sensor 260, a magnetic sensor 270, and a switch 280.

The load current sensor 220 may measure the load current. The load current sensor 220 may measure at least one of an amplitude, a frequency, and a waveform of the load current. The load current sensor 220 may transfer the measured load current to the arc characteristic filter 230.

The arc characteristic filter 230 may determine whether the transferred load current has an arc characteristic. The arc characteristic filter 230 may pass a component corresponding to the arc characteristic in the transferred load current. The arc characteristic filter 230 may filter other components than the arc characteristic from the received load current. The arc characteristic filter 230 may transfer a component corresponding to the arc characteristic from the received load current to the amplifier 240.

The amplifier 240 may receive the transmission of the component corresponding to the arc characteristic from the load current. The amplifier 240 may increase the amplitude of the component corresponding to the arc characteristic in the load current. The amplifier 240 may transfer the part corresponding to the arc characteristic that increases the amplitude in the load current to the logic circuit 250.

The logic circuit 250 may receive the transmission of the part corresponding to the arc characteristic increasing the amplitude in the load current. The logic circuit 250 may determine whether the arc occurs in the load current. For example, when the part corresponding to the arc characteristic has an amplitude that is equal to or greater than a critical amplitude, the logic circuit 250 may determine that the arc occurs in the load current. When it is determined that the arc occurs in the load current, the logic circuit 250 may transfer a control signal for opening the switch 280 to the switch 280. Accordingly, when it is determined that the arc occurs in the load current introduced from the load 210, the logic circuit 250 may open the switch 280 to interrupt the power.

The temperature sensor 260 may measure the temperature of the line wiring. When the temperature of the line wiring is equal to or greater than a critical temperature, the temperature sensor 260 may transfer a control signal for opening the switch 280 to the switch 280.

The magnetic sensor 270 may measure a magnetic field around the line wiring. When an intensity of the magnetic field around the line wiring is equal to or greater than a critical intensity, the magnetic sensor 270 may transfer a control signal for opening the switch 280 to the switch 280.

A noise current of a frequency band including the component corresponding to the arc characteristic may occur around the interrupt circuit 190. When the noise current is introduced into the interrupt circuit 190, the logic circuit 250 of the interrupt circuit 190 may wrongly recognize that the arc occurs in the load current. When the logic circuit 250 wrongly recognizes that the arc occurs in the load current, the interrupt circuit 190 may unnecessarily open the switch 280 and interrupt the power.

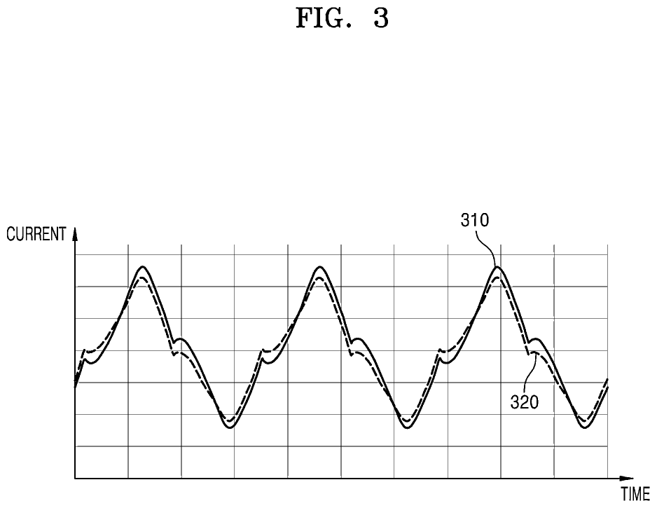

Hereinafter, a current characteristic when the interrupt circuit unnecessarily interrupts the power is described below with reference to FIG. 3.

FIG. 3 is a waveform diagram of an input current of a microwave oven and a current flowing in a high-voltage capacitor according to an embodiment of the disclosure.

Referring to FIG. 3, an input current 310 may be introduced into the microwave oven from the power unit of the microwave oven via a power line. The input current 310 may correspond to the current introduced into the microwave oven when the interrupt circuit unnecessarily interrupts the input current 310. Even when an arc does not occur in the input current 310, the input current 310 may be synchronized with the frequency of the power and may have a waveform that is similar to that when the arc occurs. For example, even when the arc does not occur in the input current 310, the input current 310 may have a peak in every designated period. The input current 310 may include the frequency component that is similar to the arc characteristic.

A current 320 flowing in the high-voltage capacitor may be the current flowing in the high-voltage capacity included in the microwave oven when the interrupt circuit unnecessarily interrupts the input current 310. Generally, the shape of the characteristic of the input current 310 may be similar to those of the current 320 flowing in the high-voltage capacitor. Due to the characteristic that the current 320 flowing in the high-voltage capacitor has similar shape and characteristic to those of the input current 310, the current 320 flowing in the high-voltage capacitor may have a peak at every designated period due to the input current 310 even when the arc does not occur in the current 320 flowing in the high-voltage capacitor. For example, the current 320 flowing in the high-voltage capacitor may have a peak at every period corresponding to the input current 310. Accordingly, the current 320 flowing in the high-voltage capacitor may include noise of the frequency band including the component corresponding to the arc characteristic of the input current 310.

The interrupt circuit 190 may be an AFCI installed in the distribution box. The AFCI may wrongly recognize that the arc occurs even when the arc does not actually occur in the input current 310 of the microwave oven and the current 320 flowing in the high-voltage capacitor included in the microwave oven. When the AFCI wrongly recognizes the arc, the power may be interrupted and the operation of the microwave oven may be stopped. When the operation of the microwave oven is unnecessarily stopped, there may be inconvenience in the use of the microwave oven.

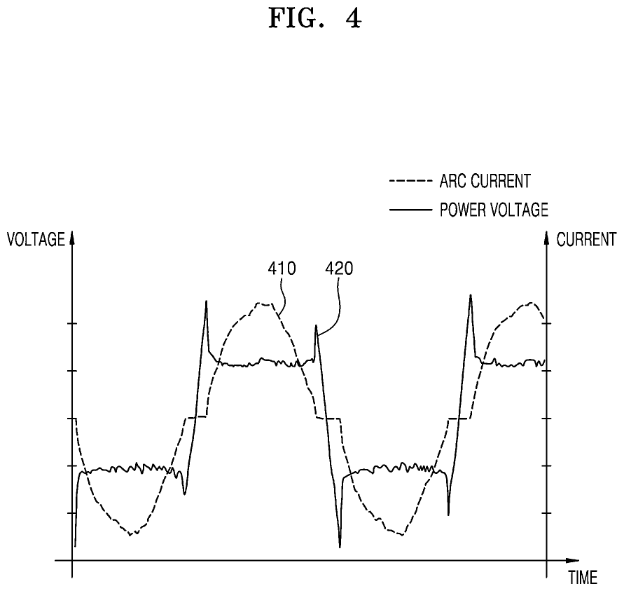

Hereinafter, current and voltage characteristics in the case in which the arc occurs are described below with reference to FIG. 4.

FIG. 4 is a waveform diagram of an arc current when a general arc occurs and a voltage of a power unit according to an embodiment of the disclosure.

Referring to FIG. 4, the arc current 310 may include a surge current that generates in a certain high-frequency band in the input current of the microwave oven. The surge current included in an arc current 410 may have a peak greater than the critical magnitude. When the interrupt circuit installed in the distribution box is the AFCI, the load current sensor included in the AFCI may detect the arc current 410. The logic circuit included in the AFCI may transform the detected arc current 410 into a voltage and analyze the voltage.

When the arc occurs, a voltage 420 of the power unit may have a waveform different from the arc current 410. When the arc occurs, a peak of the voltage 420 of the power unit may be different from the peak of the arc current 410. When the arc occurs, the peak in the voltage 420 of the power unit may be generated prior to and/or later than the peak of the arc current 410. The waveform of the input current generating during the normal operation of the microwave oven may be similar to that of the current formed when the general arc occurs.

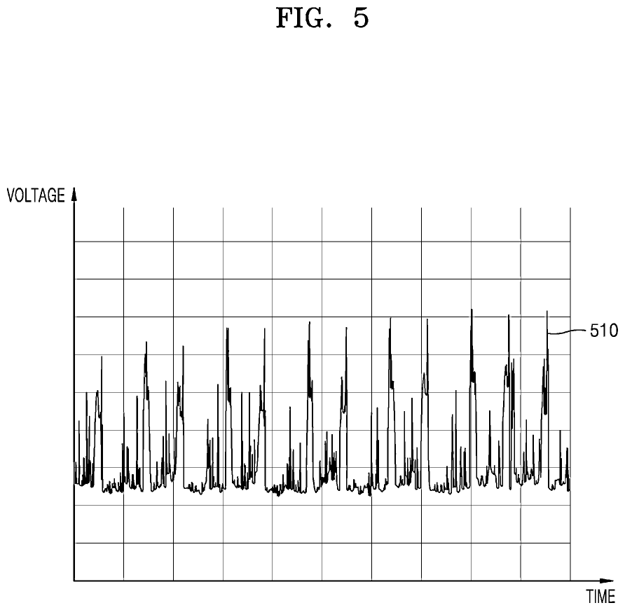

Hereinafter, the voltage characteristics when the arc occurs are described with reference to FIG. 5.

FIG. 5 is a waveform diagram of a voltage of a power unit in a microwave oven according to an embodiment of the disclosure.

Referring to FIG. 5, a voltage 510 of the power unit may be the waveform of the voltage applied to the power unit when operating the microwave oven. The voltage 510 of the power unit may be measured by using a conducted emission (CE) measurement method from among the methods of measuring electromagnetic interference (EMI). A measured frequency of the voltage 510 of the power unit may be 21.6 MHz. However, the disclosure is not limited thereto, and the measured frequency of the voltage 510 of the power unit may include a frequency value of 10 MHz to 30 MHz. A measured bandwidth of the voltage 510 of the power unit may be 300 kHz. A sweep of the voltage 510 of the power unit may be 100 ms. The voltage 510 of the power unit may be a voltage waveform from which only high-frequency components of a common mode component based on the ground (earth) and differential mode component between lines are measured.

When the microwave oven normally operates, the voltage 510 of the power unit may have a component having a similar waveform to that of the voltage 420 of the power unit described with reference to FIG. 4. When the interrupt circuit installed in the distribution box is the AFCI, the AFCI may determine that the arc has occurred when the voltage waveform having an amplitude of a certain level or greater is continued in a certain shape. When the waveform is the same as that of the voltage 510 of the power unit, the AFCI may wrongly recognize that the arc has occurred in the power supply line.

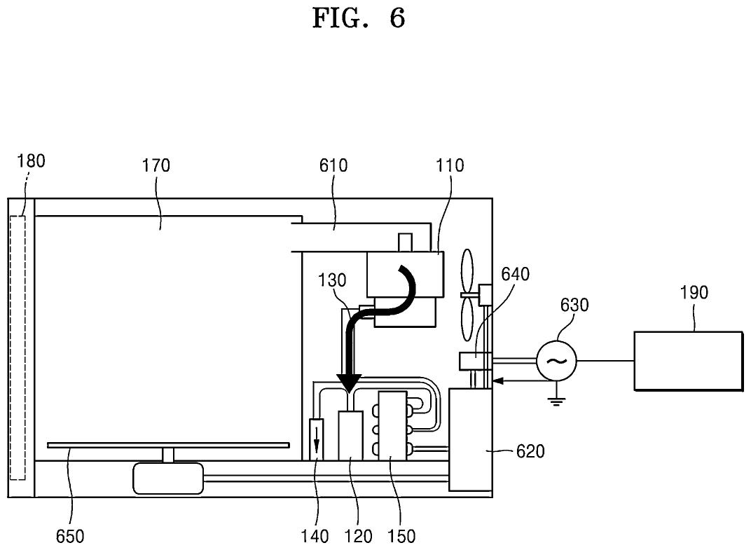

Hereinafter, a structure of a general microwave oven is described below with reference to FIG. 6.

FIG. 6 is a diagram illustrating a microwave oven according to an embodiment of the disclosure.

Referring to FIG. 6, the microwave oven may include the magnetron 110, the high-voltage capacitor 120, the current path 130, the high-voltage diode 140, the high-voltage transformer 150, the cooking chamber 170, the door 180, a waveguide 610, a controller 620, a power unit 630, an EMI filter 640, and a turn table 650. The microwave oven may omit at least some of the components shown in the drawing. For example, when the microwave oven has a direct connection method, in which the magnetron 110 and the cooking chamber 170 are directly connected without using the waveguide 610, the microwave oven may not include the waveguide 610. The microwave oven may further include components other than the components shown in the drawing. For example, the microwave oven may further include an illumination portion by which the food in the cooking chamber 170 may be identified, and a display unit displaying remaining cooking time.

The magnetron 110 may be connected to a second side of the cooking chamber 170, which is opposite to the first side to which the door 180 is coupled. The magnetron 110 may generate microwaves. A vacuum portion, a negative electrode, and a resonance circuit included in the magnetron 110 may generate microwaves by using an electromagnetic field effect. An output portion included in the magnetron 110 may output the generated microwaves to the waveguide 610.

The waveguide 610 may be connected to the magnetron 110 and the cooking chamber 170. One end of the waveguide 610 may be connected to the magnetron 110. The other end of the waveguide 610 may be connected to the cooking chamber 170. The waveguide 610 may include a metal material. The waveguide 610 may receive microwaves from the magnetron 110. The waveguide 610 may guide the microwaves. The waveguide 610 may transfer the microwaves to the cooking chamber 170.

The high-voltage capacitor 120 may be connected to the magnetron 110. The high-voltage capacitor 120 may be connected to a portion in the magnetron 110, which is opposite to the portion to which the waveguide 610 is connected. The high-voltage capacitor 120 may be connected to the ground (earth) of the microwave oven. The high-voltage capacitor 120 may charge and discharge a secondary voltage output and boosted by the high-voltage transformer 150. The high-voltage capacitor 120 may double the voltage by charging and discharging the boosted secondary voltage. A ground current output from the magnetron 110 to the ground of the microwave oven may flow in the high-voltage capacitor 120.

The high-voltage diode 140 may generate a DC voltage by rectifying the high voltage. The high-voltage diode 140 may control the flow direction of the current. The high-voltage diode 140 may prevent the current from flowing backward from the ground of the microwave oven to the magnetron 110.

The high-voltage transformer 150 may transform a load current and voltage introduced from the power unit 630 into a current and voltage used in the magnetron 110. The high-voltage transformer 150 may transfer the transformed current and voltage to the magnetron 110.

The current path 130 may connect the magnetron 110 and the high-voltage capacitor 120 to each other. The current path 130 may connect the magnetron 110 and the high-voltage diode 140 to each other. The current path 130 may connect the magnetron 110 and the high-voltage transformer 150 to each other. The current path 130 may include a plurality of wires. The ground current flowing from the magnetron 110 to the high-voltage capacitor 120, the high-voltage diode 140, and the high-voltage transformer 150 may flow through the current path 130. The ground current may generate noise while flowing. For example, the ground current may be a common mode noise current generating common mode noise.

The controller 620 may control overall operations of the microwave oven. The controller 620 may control generation and output of the microwaves in the magnetron 110. The controller 620 may control the rotating operation of the turn table 650. The controller 620 may detect opening/closing of the door 180. The controller 620 may control the microwave oven so that the microwave oven operates only when the door 180 is closed.

The EMI filter 640 may filter the noise current generated in the power unit 630.

A current flowing from the magnetron 110 to the high-voltage capacitor 120, the high-voltage diode 140, and the high-voltage transformer 150 may flow through the current path 130. The current may be generated in the magnetron 110 and flow to the ground of the microwave oven. The current generated in the magnetron 110 and flowing to the ground of the microwave oven may generate noise including high-frequency components. The high-frequency components included in the noise may include frequency components that may be generated when the arc occurs. The current generated in the magnetron 110 and flowing to the ground of the microwave oven may be discharged to the power unit 630. The current discharged to the power unit 630 may be introduced into the interrupt circuit 190 that may be implemented as the AFCI.

The interrupt circuit 190 may be installed in the distribution box. The interrupt circuit 190 may be connected to the power unit 630. The interrupt circuit 190 may detect the arc occurring in the load current introduced from the power unit 630 to the EMI filter 640. When recognizing that the arc has occurred, the interrupt circuit 140 may interrupt the power unit 630. The application range of the interrupt circuit 190 has been increasing so as to be mandatorily installed in the distribution box of a building.

When the interrupt circuit 140 is the AFCI, the current generated in the magnetron 110 and flowing to the ground of the microwave oven may be introduced into the AFCI. When the current is introduced into the AFCI, the AFCI may detect the high-frequency component included in the noise generated by the current. The AFCI may detect the high-frequency component included in the noise generated by the current and may wrongly recognize that the arc has occurred. When the AFCI wrongly recognizes the high-frequency component included in the noise generated by the current as the arc, the power unit 630 may be unnecessarily interrupted.

The high-frequency component included in the noise generated in the current may be introduced into the interrupt circuit 190 without passing through the EMI filter 640. The high-frequency component included in the noise generated by the current may have characteristics that may be difficult to be interrupted or restrained by the filter circuit included in the EMI filter 640 connected to the power unit 630. The above issue may be prevented only when the generation of the high-frequency component having the characteristic that is difficult to be interrupted or restrained by the filter circuit included in the EMI filter 640 is restrained. Accordingly, in order to restrain the high-frequency component included in the noise generated by the current from generating, the phenomenon in which the noise of the current is generated needs to be restrained.

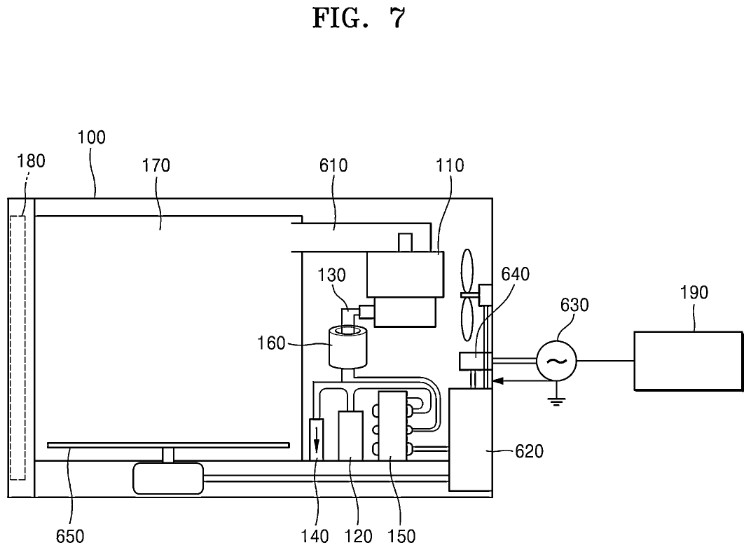

Hereinafter, the structure of the microwave oven in which the magnetic body is arranged is described below with reference to FIG. 7.

FIG. 7 is a diagram illustrating a microwave oven according to an embodiment of the disclosure.

Referring to FIG. 7, the microwave oven 100 may include the magnetron 110, the high-voltage capacitor 120, the current path 130, the high-voltage diode 140, the high-voltage transformer 150, the magnetic body 160, the cooking chamber 170, the door 180, a waveguide 610, a controller 620, a power unit 630, an EMI filter 640, and a turn table 670. From among the elements of the microwave oven 100 of FIG. 7, the elements denoted by the same reference numerals as those of the microwave oven described above with reference to FIG. 6 may have substantially the same structures and functions. Therefore, the same descriptions as those of FIG. 6 are omitted hereinafter, and newly added elements, structures, and functions are described below.

The magnetic body 160 may be arranged adjacent to the current path 130 connecting between the magnetron 110 and the high-voltage capacitor 120. The magnetic body 160 may be arranged adjacent to the current path 130 connecting between the magnetron 110 and the high-voltage diode 140. The magnetic body 160 may be arranged adjacent to the current path 130 connecting between the magnetron 110 and the high-voltage transformer 150. The magnetron 110 and the high-voltage capacitor 120, the high-voltage diode 140, and the high-voltage transformer 150 may be connected via a plurality of wires. The current path 130 may include a plurality of wires in which the current flowing from the magnetron 110 to the ground of the microwave oven 100 through the high-voltage capacitor 120, the high-voltage diode 140, and the high-voltage transformer 150 flows. The magnetic body 160 may be arranged so that the plurality of wires entirely pass through the magnetic body 160. The magnetic body 160 may be arranged so as to entirely surround the plurality of wires through which the flowing from the magnetron 110 to the ground of the microwave oven 100 flows.

The magnetic body 160 may surround the current path 130. For example, the magnetic body 160 may surround the current path 130 so that the inner surface of the magnetic body 160 comes into contact with the current path 130. For example, the magnetic body 160 may surround the current path while the inner surface of the magnetic body 160 is spaced apart a certain distance from the current path 130. According to the size of the magnetic body 160, a property of a material forming the magnetic body 160, and a size of a marginal space around the current path 130, whether the magnetic body 160 comes into contact with the current path 130 and a spaced distance between the magnetic body 160 and the current path 130 may be set.

A position of arranging the magnetic body 160 may be variously set on the current path 130. As shown in FIG. 7, the magnetic body 160 may be arranged at the center of the current path 130 connecting between the magnetron 110 and the high-voltage capacitor 120, the high-voltage diode 140, and the high-voltage transformer 150. For example, the magnetic body 160 may be arranged adjacent to the magnetron 110 on the current path 130 that connects between the magnetron 110 and the high-voltage capacitor 120, the high-voltage diode 140, and the high-voltage transformer 150. For example, the magnetic body 160 may be arranged adjacent to the high-voltage capacitor 120, the high-voltage diode 140, and the high-voltage transformer 150 on the current path 130 that connects between the magnetron 110 and the high-voltage capacitor 120, the high-voltage diode 140, and the high-voltage transformer 150.

The magnetic body 160 may be a ferrite magnetic body. The ferrite magnetic body may be a ferromagnetic body. The ferrite magnetic body may include iron oxide (Fe₂O₃). For example, the ferrite magnetic body may include at least one of manganese ferrite, nickel-zinc ferrite, strontium ferrite, barium ferrite, and cobalt ferrite.

When the magnetic body 160 is arranged so as to surround the cross-section through which the current flows, the flow of the current may be restrained. When the magnetic body 160 is arranged so as to surround the current path 130, the flow of the current through the current path 130 may be restrained and the noise generated from the current may be shielded. When the magnetic body 160 is arranged to surround the current path 130, the phenomenon in which the interrupt circuit 140 wrongly recognizes the noise generated by the current as an arc may be reduced.

According to the microwave oven of the embodiment of the disclosure, the mis-recognition of the AFCI may be reduced, and the issue in which the AFCI interrupts the power even when the arc does not occur in the load current of the power unit may be reduced.

The microwave oven according to an embodiment of the disclosure may stably operate by reducing the issue in which the AFCI unnecessarily interrupts the power due to the mis-recognition regarding the generation of arc.

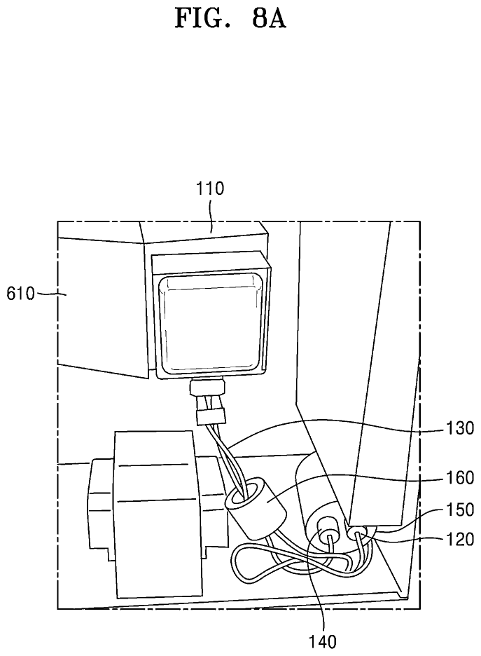

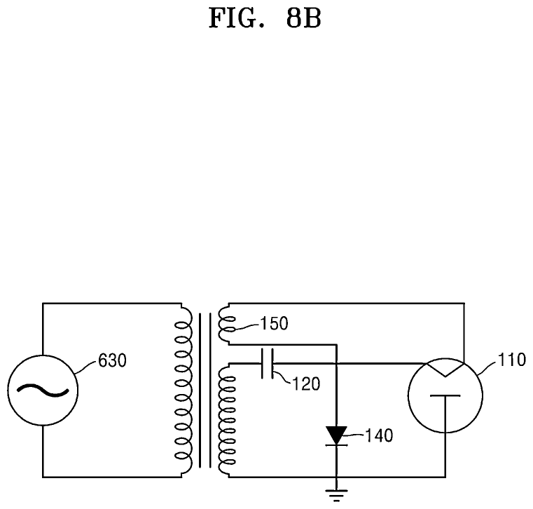

Hereinafter, a structure in which the magnetic body is arranged to surround the current path is described with reference to FIG. 8A.

FIG. 8A is a diagram illustrating a magnetron, a high-voltage capacitor, a high-voltage diode, a high-voltage transformer, a current path, and a magnetic body in a microwave oven according to an embodiment of the disclosure.

Referring to FIG. 8A, the current path 130 may connect the magnetron 110 and the high-voltage capacitor 120 to each other. The current path 130 may connect the magnetron 110 and the high-voltage diode 140 to each other. The current path 130 may connect the magnetron 110 and the high-voltage transformer 150 to each other. The current path 130 may be a path through which the current flows from the magnetron 110 to the ground of the microwave oven through the high-voltage capacitor 120, the high-voltage diode 140, and the high-voltage transformer 150. The current path 130 may include a plurality of wires connecting the magnetron 110 to the high-voltage capacitor 120, the high-voltage diode 140, and the high-voltage transformer 150. For example, the current path 130 may include a wire harness connecting the magnetron 110 to the high-voltage capacitor 120, the high-voltage diode 140, and the high-voltage transformer 150.

The magnetic body 160 may be a cylinder at least partially surrounding the current path 130. The magnetic body 160 may include ferrite having a cylindrical shape. The magnetic body 160 may have a cylindrical shape surrounding at least one of the center portion of the current path 130, the portion adjacent to the magnetron 110, and the portions adjacent to the high-voltage capacitor 120, the high-voltage diode 140, and the high-voltage transformer 150. The magnetic body 160 may have a cylindrical shape surrounding the entire current path 130. The magnetic body 160 may have a polygonal pillar shape at least partially surrounding the current path 130.

FIG. 8A shows a magnetic body having a single cylindrical shape, but is not limited thereto, and a magnetic body may have various shapes and structures. Hereinafter, various shapes and structures that the magnetic body 160 may have are described below.

Referring to FIG. 8A, the magnetic body 160 may have a first part and a second part. One end of the first part may be attached to one end of the second part. The other end of the first part may be coupled to and separated from the other end of the second part. For example, the other end of the first part and the other end of the second part may have a tongs-shaped structure that may be coupled and separated. The magnetic body 160 having the first part and the second part may have a component that is in an unfolded state before being arranged to surround the current path 130. The first part and the second part may be coupled to each other so as to at least partially surround the current path 130. When the first part and the second part are coupled to each other, the tongs-shaped structures at the other end of the first part and the other end of the second part may be coupled. When the magnetic body 160 includes the first part and the second part, the magnetic body 160 may be easily assembled with the microwave oven, the manufacturing of which is finished.

The magnetic body 160 may be a loop at least partially surrounding the current path 130. The magnetic body 160 having the loop shape may have a less length as compared with the magnetic body 160 having the cylindrical shape. The current path 130 may pass through the center of the loop of the magnetic body 160. The magnetic body 160 may restrain the current flowing through the center of the loop. In order to increase the effect of restraining the current flowing through the center of the loop, a plurality of conductive lines may be arranged along the loop. For example, the plurality of conductive lines may be wound as coils on the inside or outside of the magnetic body 160 of the loop shape.

The magnetic body 160 may be arranged to surround the current path 130. The magnetic body 160 may be arranged so that the plurality of wires connecting the magnetron 110 to the high-voltage capacitor 120, the high-voltage diode 140, and the high-voltage transformer 150 may entirely pass through the magnetic body 160. The magnetic body 160 may restrain a common mode current flowing from the magnetron 110 to the ground of the microwave oven.

The magnetic body 160 may have an impedance that is greater than or equal to a critical value designated in the frequency band in which the noise generated from the current flowing along the current path 130 is included. For example, the magnetic body 160 may have a resistance that is greater than or equal to a critical value designated in the frequency band including the noise. When the magnetic body 160 has the resistance that is greater than or equal to the critical value designated in the frequency band including the noise, the current flowing along the current path 130 may be lost in the magnetic body 160. For example, the magnetic body 160 may have an inductance that is greater than or equal to a critical value designated in the frequency band including the noise. When the magnetic body 160 has the inductance that is greater than or equal to the critical value set in the frequency band including the noise, the magnetic body 160 may perform a function of an open circuit and block the current flowing along the current path 130.

The frequency band including the noise may include a frequency value of 21.6 MHz. The frequency value of 21.6 MHz may be substantially the same as the frequency value of the arc current when the arc occurs. The frequency value of 21.6 MHz may be substantially the same as the frequency value at which the interrupt circuit installed in the distribution box and implemented as the AFCI wrongly recognizes that the arc has occurred. However, the disclosure is not limited thereto, and the frequency band including the noise may include the frequency value of 10 MHz to 30 MHz. When the current flowing through the current path 130 is blocked so as to block the noise, the mis-recognition of the arc in the interrupt circuit may be reduced.

Hereinafter, circuit structures of the magnetron, the high-voltage capacitor, the high-voltage diode, the high-voltage transformer, and the power unit are described below with reference to FIG. 8B.

FIG. 8B is a circuit diagram illustrating a magnetron, a high-voltage capacitor, a high-voltage diode, a high-voltage transformer, and a power unit in a microwave oven according to an embodiment of the disclosure.

Referring to FIG. 8B, the magnetron 110 may be electrically connected to the high-voltage capacitor 120, the high-voltage diode 140, and the high-voltage transformer 150. The high-voltage capacitor 120 and the high-voltage diode 140 may be in parallel with each other and connected to the magnetron 110. The high-voltage capacitor 120 and the high-voltage diode 140 that are parallel to each other may be connected at a branch point in the center of the high-voltage transformer 150.

The power unit 630 may transfer an input voltage and an input current to the high-voltage transformer 150. The high-voltage transformer 150 may transform the input voltage and the input current received from the power unit 630 into a voltage and a current that the magnetron 110 may use. The high-voltage capacitor 120 and the high-voltage diode 140 may smooth and rectify the transformed voltage and current and transfer the voltage and current to the magnetron 110.

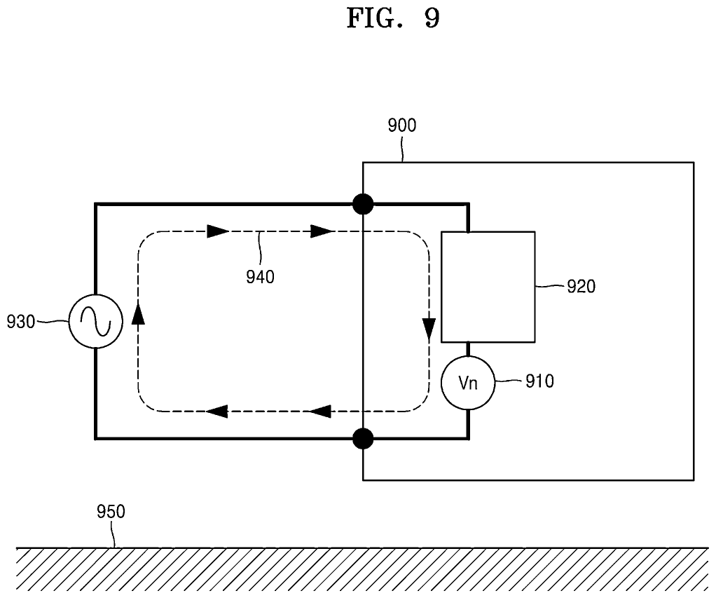

Hereinafter, the noise in a differential mode (DM) is described below with reference to FIG. 9.

FIG. 9 is a diagram illustrating a microwave oven operating in a differential mode according to an embodiment of the disclosure.

Referring to FIG. 9, a microwave oven 900 operating in the differential mode may include a noise source 910, an internal circuit 920, and a power source 930.

The differential mode may be a mode in which a noise current 940 flows in the same path as a current flowing due to energy supply from the power source 930. The noise current 940 generating differential mode noise may be the noise current flowing in the same path as that of the current from the power source 930. The differential mode noise may be a normal mode noise.

The noise source 910 may denote a circuit, an element, or an electrical component that becomes a cause of generating noise in the microwave oven 900. The noise source 910 may have a neutral voltage Vn. When the noise source 910 has the neutral voltage Vn and a noise voltage occurs between the power source 930 and a connected line, the differential mode noise may occur.

The noise source 910 in the differential mode may be connected in series with the line connected to the power source 930. The noise current 940 in the differential mode may flow in the same direction as the power current and may generate noise in the line connected to the power source 930.

In the noise source 910 of the differential mode, the direction in which the noise is input and the direction in which the noise current 940 of the differential mode outputs may be opposite to each other. Because the input direction of the noise source 910 and the output direction of the noise current 940 are opposite to each other, it may be referred to as the differential mode. When the noise source 910 inputting noise and the noise current 940 outputting noise are irrelevant with the ground 950 and the noise is generated along a normal current path, it may be referred to as a normal mode. The noise current 940 generated in the differential mode may be shielded by the EMI filter included in the internal circuit 920.

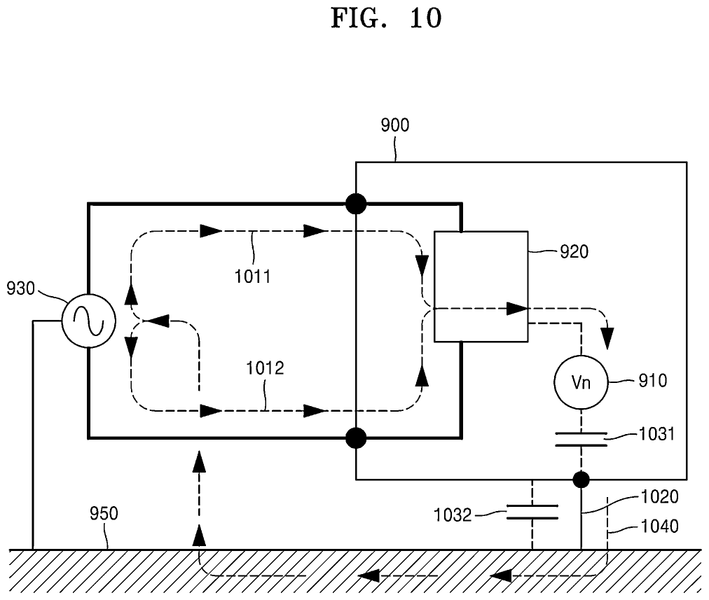

Hereinafter, the noise in the common mode (CM) is described below with reference to FIG. 10.

FIG. 10 is a diagram illustrating a microwave oven operating in a common mode according to an embodiment of the disclosure.

Referring to FIG. 10, the microwave oven 900 operating in the common mode may include a noise source 910, an internal circuit 920, and a power source 930.

The common mode may be a mode in which a noise voltage is generated between the line connected to the power source 930 and the ground 950. In the common mode, the noise voltage may not be generated between the power lines connected to the power source 930.

A first common mode noise current 1011 may be output from a first electrode of the power source 930. A second common mode noise current 1012 may be output from a second electrode of the power source 930. The first common mode noise current 1011 and the second common mode noise current 1012 may be output from a positive electrode and a negative electrode of the power source 930. The first common mode noise current 1011 and the second common mode noise current 1012 may flow to the noise source 910 via the internal circuit 920. Because the direction in which the first common mode noise current 1011 and the second common mode noise current 1012 flow is toward the noise source 910 via the inner circuit 920, it may be referred to as the common mode.

The first common mode noise current 1011 and the second common mode noise current 1012 may leak out of the microwave oven 900 via a first stray capacitance 1031 formed between the noise source 910 and a ground passage 1020 provided on an exterior case of the microwave oven 900. The first stray capacitance 1031 may be a parasitic capacitor formed between the noise source 910 and the ground passage 1020.

The ground passage 1020 may connect the exterior case of the microwave oven 900 to the ground 950. A second stray capacitance 1032 may be formed between the exterior case of the microwave oven 900 and the ground 950, separately from the ground passage 1020. The second stray capacitance 1032 may be a parasitic capacitor formed between the exterior case of the microwave oven 900 and the ground 950.

The first common mode noise current 1011 and the second common mode noise current 1012 leaking out of the microwave oven 900 may be combined to form a common mode noise current 1040. The common mode noise current 1040 may pass through the ground 950 via the second stray capacitance 1032. The common mode noise current 1040 may be introduced into the line connected to the power source 930 via the ground 950.

Hereinafter, principles of restraining the common mode noise current by the magnetic body according to an embodiment of the disclosure are described below.

The magnetic body according to an embodiment of the disclosure may restrain the common mode noise current generated along the current path. The magnetic body according to an embodiment of the disclosure may restrain the common mode noise current flowing from the magnetron to the ground. The magnetic body according to an embodiment of the disclosure may be arranged so that the plurality of wires included in the current path entirely pass through the magnetic body in order to restrain the common mode noise current, the current path connecting the magnetron to the high-voltage capacitor, the high-voltage diode, and the high-voltage transformer. When the magnetic body is arranged so that the plurality of wires entirely pass through the magnetic body, the high-frequency band component in the common mode noise current may be only restrained or high-frequency band component may be only lost without interfering with the flow of the normal current due to the impedance value of the magnetic body. The magnitude and frequency characteristic of the impedance may vary depending on the size of the magnetic body, the material of the magnetic body, and the number of times of winding coils included in the magnetic body. The size of the magnetic body, the material of the magnetic body, and the number of times of winding the coil in the magnetic body may be set based on the magnitude and frequency of the high-frequency component desired to be attenuated. When the size of the magnetic body, the material of the magnetic material, and the number of times of winding coils included in the magnetic body are set to correspond to the high-frequency component included in the common mode noise current, the common mode high-frequency component included in the current flowing along the inside of the magnetic body may be restrained. When the common mode high-frequency component included in the current flowing along the inside of the magnetic body is restrained, the issues of mis-recognizing the common mode high-frequency component as the arc in the power voltage in the interrupt circuit installed in the distribution box may be reduced.

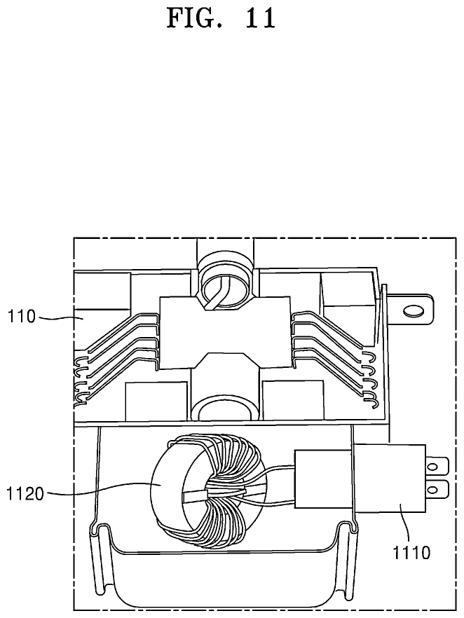

Hereinafter, the structure in which an interrupt coil is arranged in the magnetron is described with reference to FIG. 11.

FIG. 11 is a diagram illustrating a magnetron, a connector, and an interrupt coil in a microwave oven according to an embodiment of the disclosure.

Referring to FIG. 11, the magnetron 110 may generate and output microwaves. The magnetron 110 may output the generated microwaves to the cooking chamber included in the microwave oven.

A connector 1110 may be connected to the magnetron 110. In the connector 1110, the current introduced from the power unit to the magnetron 110 or output from the magnetron 110 may flow. The current path may connect the magnetron and the connector to each other. In the current path, the current flowing from the magnetron 110 to the connector 1110 and generating noise may flow.

An interrupt coil 1120 may be arranged adjacent to the current path connecting the magnetron and the connector to each other. The interrupt coil 1120 may be inserted into the magnetron 110 or the connector 1110 so as to surround the current path.

FIG. 11 shows an example in which the interrupt coil 1120 is inserted into the magnetron 110. The interrupt coil 1120 may be arranged in the magnetron 110 in the type of a common mode choke coil. The common mode choke coil may have a shape in which a pair of coils are wound in the same direction so as to restrain the common mode current. The common mode choke coil may be arranged in the magnetron 110 to be connected to the current path in series. When the current path and the common mode choke coil are connected in series, rapid change in the common mode noise current in the current flowing along the current path may be restrained. When the rapid change in the common mode noise current flowing along the current path is restrained, the noise generated from the common mode noise current flowing along the current path may be reduced.

The interrupt coil 1120 may be a ferrite coil. When the interrupt coil 1120 is the ferrite coil, the performance of blocking the current generating the noise may be improved.

The interrupt coil 1120 may be arranged adjacent to the ground of the magnetron 110. The current output from the magnetron 110 may be gathered at the ground of the magnetron 110. When being arranged in the magnetron 110, the interrupt coil 1120 may be arranged at the part where the current output from the magnetron 110 is collected. When the interrupt coil 1120 is arranged adjacent to the ground of the magnetron 110, the performance of blocking the current generating the noise may be improved.

The interrupt coil 1120 may be mounted to be connected to internal lines in the connector 1110. The internal lines of the connector 1110 may be connected to each of the pair of coils forming the interrupt coil 1120. The interrupt coil 1120 may only block the noise current while allowing the power current to flow through the internal lines of the connector 1110.

The interrupt coil 1120 may be the choke coil restraining the common mode noise current generated along the current path. The interrupt coil 1120 may be the choke coil restraining the high-frequency component included in the common mode noise.

The interrupt coil 1120 may have an impedance that is greater than or equal to a critical value set in the frequency band including the noise. The interrupt coil 1120 may have an inductance that is greater than or equal to a critical value or a resistance greater than or equal to a critical value in the frequency band including the noise. Accordingly, the interrupt coil 1120 may operate as an open circuit or block the noise through loss in the frequency band including the noise.

The frequency band may have a frequency value of 21.6 MHz. The frequency value of 21.6 MHz may be the frequency value of the high-frequency component included in the arc current. When the noise of the frequency band including the frequency value of 21.6 MHz is blocked, the issue in which the interrupt circuit wrongly recognizes the noise as the arc current and interrupts the power unit may be reduced. However, the disclosure is not limited thereto, and the frequency band including the noise may include the frequency value of 10 MHz to 30 MHZ.

The impedance of the interrupt coil 1120 may be set based on at least one of the size of the interrupt coil 1120, the material of the interrupt coil 1120, and the number of times of winding the interrupt coil 1120. When the impedance of the interrupt coil 1120 is set to have a value greater than or equal to the critical value set in the frequency band including the noise, the noise may be effectively blocked.

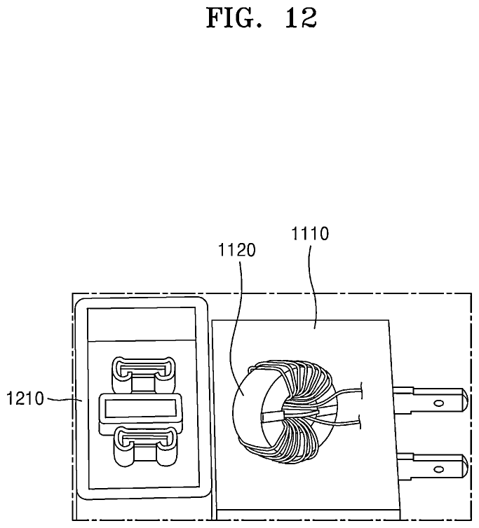

Hereinafter, the structure in which the interrupt coil is arranged in the connector is described below with reference to FIG. 12.

FIG. 12 is a diagram illustrating an exterior component, a connector, and an interrupt coil in a microwave oven according to an embodiment of the disclosure.

Referring to FIG. 12, an exterior component 1210 may be connected to the magnetron. The exterior component 1210 may be arranged to protrude to the outside of the microwave oven.

The connector 1110 may be connected to the exterior component 1210. The current introduced from the power unit to the magnetron via the exterior component 1210 or output from the magnetron via the exterior component 1210 may flow in the connector 1110. The current path may connect the magnetron and the connector to each other. In the current path, the current flowing from the magnetron to the connector 1110 and generating noise may flow.

The interrupt coil 1120 may be arranged adjacent to the current path connecting the exterior component 1210 connected to the magnetron and the connector to each other. The interrupt coil 1120 may be inserted into the exterior component 1210 or the connector 1110 so as to surround the current path.

FIG. 12 shows an example in which the interrupt coil 1120 is inserted in the connector 1110. The interrupt coil 1120 may be arranged while being mounted in the connector 1110 as a choke coil, the connector 1110 being connected to the exterior component 1210 connected to the magnetron. When the interrupt coil 1120 is inserted in the connector 1110, the interrupt coil 1120 may be implemented as a separate exterior component directly connected to the exterior component 1210 connected to the magnetron. The choke coil may be a common mode choke coil in which a pair of coils are wound in the same direction so as to restrain the common mode current. The common mode choke coil may be inserted into the connector 1110 and may be connected to the current path in series. When the current path and the common mode choke coil are connected in series, rapid change in the common mode noise current in the current flowing along the current path may be restrained. When the rapid change in the common mode noise current flowing along the current path is restrained, the noise generated from the current flowing along the current path may be reduced.

The interrupt coil 1120 may be arranged adjacent to a current input unit of the connector 1110. A current introduced into the connector 1110 may be collected at the current input unit of the connector 1110. The interrupt coil 1120 may be arranged at the part where the current introduced into the connector 1110 is collected, when inserted into the connector 1110. When the interrupt coil 1120 is arranged adjacent to the current input unit of the connector 1110, the performance of blocking the current generating the noise may be improved.

The interrupt coil 1120 may be mounted to be connected to the exterior component 1210 connected to the magnetron. The exterior component 1210 connected to the magnetron may be connected to each of the pair of coils forming the interrupt coil 1120. The interrupt coil 1120 may block the noise current only while allowing the power current to flow to the exterior component 1210 connected to the magnetron.

FIGS. 11 and 12 show the structures in which the interrupt coil is arranged in the magnetron or the connector. However, the disclosure is not limited thereto, and the interrupt coil may be arranged out of the magnetron and the connector.

Hereinafter, an example in which the interrupt coil is arranged out of the magnetron and the connector is described below.

The microwave oven may include a high-voltage capacitor, a high-voltage diode, and a high-voltage transformer connected to the magnetron. The microwave oven may include a printed circuit board (PCB) connecting the magnetron to the high-voltage capacitor, the high-voltage diode, and the high-voltage transformer. When the interrupt coil is arranged on the outer portion of the magnetron, the interrupt coil may be arranged on the PCB. The interrupt coil may be mounted on the PCB. The interrupt coil mounted on the PCB may be connected to the wires included in the current path.

When the interrupt coil is arranged on the outer portion of the magnetron, at least a part of the interrupt coil may be arranged between the magnetron and the connector so as to be connected to the current path. The interrupt coil may be connected to the wire included in the current path in the form of a single coil.

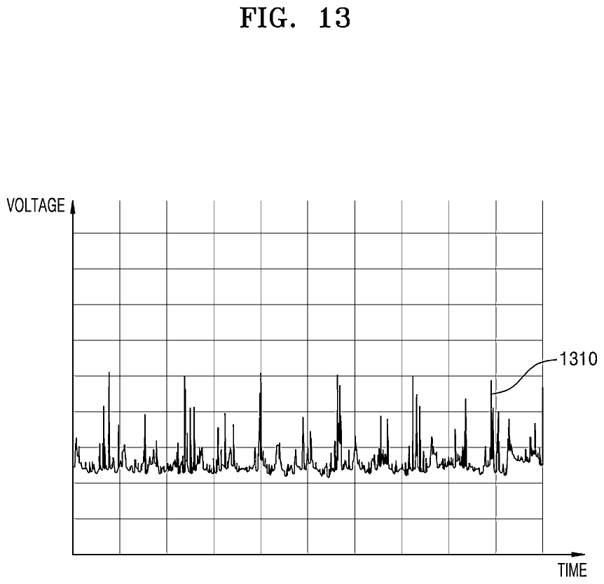

Hereinafter, a voltage waveform diagram in the case in which the magnetic coil or the interrupt coil is arranged is described below with reference to FIG. 13.

FIG. 13 is a waveform diagram of a voltage in a microwave oven including a magnetic body according to an embodiment of the disclosure.

Referring to FIG. 13, it shows a waveform of a voltage 1310 of the power unit when the magnetic body is arranged on the current path of the current flowing from the magnetron to the ground or when the interrupt coil is connected to the wire.

When the magnetic body is arranged on the current path of the current flowing from the magnetron to the ground or the interrupt coil is connected to the wire, a peak amplitude of the voltage 1310 of the power unit may be reduced. When the magnetic body is arranged on the current path of the current flowing from the magnetron to the ground or the interrupt coil is connected to the wire, a high-frequency component of the voltage 1310 of the power unit may be reduced. When the magnetic body is arranged on the current path of the current flowing from the magnetron to the ground or the interrupt coil is connected to the wire, a waveform or component having the shape that may be misrecognized as an arc in the voltage 1310 of the power unit may be reduced.

According to an embodiment of the disclosure, a microwave oven includes a main body including a cooking chamber having an opening that is opened forward, a door coupled to the main body and capable of opening/closing the cooking chamber, a magnetron that generates microwaves and is connected to a second side of the cooking chamber, the second side being opposite to a first side to which the door is coupled, a high-voltage capacitor connected to the magnetron; a high-voltage diode connected to the magnetron, a high-voltage transformer connected to the magnetron, and a magnetic body arranged adjacent to a current path connecting the magnetron to the high-voltage capacitor, wherein, along the current path, a current flows from the magnetron to the high-voltage capacitor, and the magnetic body surrounds the current path.

According to an embodiment of the disclosure, the magnetic body may be a ferrite magnetic body.

According to an embodiment of the disclosure, the magnetic body may be a cylinder at least partially surrounding the current path.

According to an embodiment of the disclosure, the magnetic body may include a first part and a second part, and the first part and the second part may be coupled to at least partially surround the current path.

According to an embodiment of the disclosure, the magnetic body may be a loop at least partially surrounding the current path.

According to an embodiment of the disclosure, a plurality of conductive lines may be arranged along the loop.

According to an embodiment of the disclosure, the magnetic body may have an impedance that is greater than or equal to a critical value set in the frequency band including the noise.

According to an embodiment of the disclosure, the frequency band may include the frequency value of 10 MHz to 30 MHZ.

According to an embodiment of the disclosure, the magnetic body may restrain a common mode noise current generated along the current path.

According to an embodiment of the disclosure, the magnetron and the high-voltage capacitor may be connected to each other via a plurality of wires, and the magnetic body may be mounted so that the plurality of wires entirely pass through the magnetic body.

According to an embodiment of the disclosure, a microwave oven includes a main body including a cooking chamber having an opening that is opened forward, a door coupled to the main body and capable of opening/closing the cooking chamber, a magnetron that generates microwaves and is connected to a second side of the cooking chamber, the second side being opposite to a first side to which the door is coupled, a connector connected to the magnetron, and an interrupt coil arranged adjacent to a current path connecting the magnetron to the connector, wherein, along the current path, a current flows from the magnetron to the connector, and the interrupt coil is inserted into the magnetron or the connector so as to surround the current path.

According to an embodiment of the disclosure, the interrupt coil may be a ferrite coil.

According to an embodiment of the disclosure, the interrupt coil may be arranged adjacent to a ground of the magnetron.

According to an embodiment of the disclosure, the interrupt coil may be mounted to be connected to an internal line of the connector.

According to an embodiment of the disclosure, the interrupt coil may be a choke coil restraining a common mode noise current generated along the current path.

According to an embodiment of the disclosure, the interrupt coil may have an impedance that is greater than or equal to a critical value set in the frequency band including the noise.

According to an embodiment of the disclosure, the frequency band may include the frequency value of 10 MHz to 30 MHZ.

According to an embodiment of the disclosure, an impedance of the interrupt coil may be set based on at least one of a size of the interrupt coil, a material of the interrupt coil, and the number of times of winding the interrupt coil.

According to an embodiment of the disclosure, a high-voltage capacitor connected to the magnetron and a printed circuit board (PCB) connecting the magnetron to the high-voltage capacitor are further provided, and the interrupt coil may be arranged on the PCB.

According to an embodiment of the disclosure, the interrupt coil may be at least partially arranged between the magnetron and the connector so as to be connected to the current path.

According to an embodiment of the disclosure, noise generated from the current flowing from the magnetron to the high-voltage capacitor, the high-voltage diode, and the high-voltage transformer provided in the microwave oven may be reduced. Accordingly, the phenomenon in which the interrupt circuit mis-recognizes that the arc occurs even when the arc does not actually occur may be reduced. Accordingly, the operation of the microwave oven may not be unnecessarily stopped due to the mis-recognition of the arc in the interrupt circuit.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A microwave oven comprising:
a main body including a cooking chamber having an opening that is opened forward;
a door coupled to the main body and capable of opening/closing the cooking chamber,
a magnetron that generates microwaves and is connected to a second side of the cooking chamber, the second side being opposite to a first side to which the door is coupled;
a high-voltage capacitor connected to the magnetron;
a high-voltage diode connected to the magnetron;
a high-voltage transformer connected to the magnetron; and
a magnetic body arranged adjacent to a current path connecting the magnetron to the high-voltage capacitor, the high-voltage diode, and the high-voltage transformer,
wherein, along the current path, a current flows from the magnetron to the high-voltage capacitor, the high-voltage diode, and the high-voltage transformer, and
wherein the magnetic body surrounds the current path.

2. The microwave oven of claim 1, wherein the magnetic body is a ferrite magnetic body.

3. The microwave oven of claim 1, wherein the magnetic body is a cylinder at least partially surrounding the current path.

4. The microwave oven of claim 1,
wherein the magnetic body includes a first part and a second part; and
wherein the first part and the second part are coupled to at least partially surround the current path.

5. The microwave oven of claim 1, wherein the magnetic body is a loop at least partially surrounding the current path.

6. The microwave oven of claim 5, wherein a plurality of conductive lines are arranged along the loop.

7. The microwave oven of claim 1, wherein the magnetic body has an impedance that is greater than or equal to a critical value set in a frequency band including noise.

8. The microwave oven of claim 7, wherein the frequency band includes a frequency value of 10 megahertz (MHz) to 30 MHz.

9. The microwave oven of claim 1, wherein the magnetic body restrains a common mode noise current generated along the current path.

10. The microwave oven of claim 1,
wherein the magnetron and the high-voltage capacitor are connected to each other via a plurality of wires; and
wherein the magnetic body is mounted so that the plurality of wires entirely pass through the magnetic body.

11. A microwave oven comprising:
a main body including a cooking chamber having an opening that is opened forward;
a door coupled to the main body and capable of opening/closing the cooking chamber;
a magnetron that generates microwaves and is connected to a second side of the cooking chamber, the second side being opposite to a first side to which the door is coupled;
a connector connected to the magnetron; and
an interrupt coil arranged adjacent to a current path connecting the magnetron to the connector,
wherein, along the current path, a current flows from the magnetron to the connector, and
wherein the interrupt coil is inserted into the magnetron or the connector so as to surround the current path.

12. The microwave oven of claim 11, wherein the interrupt coil is a ferrite coil.

13. The microwave oven of claim 11, wherein the interrupt coil is arranged adjacent to a ground of the magnetron.

14. The microwave oven of claim 11, wherein the interrupt coil is mounted so as to be connected to an internal line of the connector.

15. The microwave oven of claim 11, wherein the interrupt coil is a choke coil restraining a common mode noise current generated along the current path.
